(19) United States
(12) Patent Application Publication
(10) Pub. No.: US 2023/0300877 A1
(43) Pub. Date: Sep. 21, 2023

(54) DYNAMIC ALLOCATION OF COMMUNICATION NETWORK RESOURCES FOR AUTONOMOUS VEHICLES

(71) Applicant: TuSimple, Inc., San Diego, CA (US)

(72) Inventor: Joyce TAM, Pleasanton, CA (US)

(73) Assignee: TuSimple, Inc., San Diego, CA (US)

(21) Appl. No.: 18/187,087

(22) Filed: Mar. 21, 2023

Related U.S. Application Data
(60) Provisional application No. 63/269,679, filed on Mar. 21, 2022.

(51) Int. Cl. H04W 72/566; H04W 72/12

(52) U.S. Cl. CPC H04W 72/566; H04W 72/12

(57) ABSTRACT

Various embodiments of the present invention provide methods, apparatus, systems, computing devices, computing entities, and/or the like for dynamic allocation of communication network resources by an autonomous vehicle. For example, certain embodiments of the present invention utilize systems, methods, and computer program products that determine a data transmission prioritization policy and cause an auxiliary data object to be provided based at least in part on the data transmission prioritization policy.

### CROSS-REFERENCE TO RELATED APPLICATIONS

This application claims benefit of U.S. Provisional Application No. 63/269,679 filed Mar. 21, 2022, the entire contents of which are incorporated herein by reference.

### TECHNICAL FIELD

The present disclosure relates generally to autonomous vehicles. More particularly, the present disclosure is related to the dynamic allocation of communication network resources by an autonomous vehicle (AV).

### BACKGROUND

One aim of autonomous vehicle technologies is to provide vehicles that can safely navigate towards a destination with limited or no driver assistance. The safe navigation of an AV from one point to another may include the ability to signal other vehicles, navigating around other vehicles in shoulders or emergency lanes, changing lanes, biasing appropriately in a lane, and navigate all portions or types of highway lanes. Autonomous vehicle technologies may enable an AV to operate without requiring extensive learning or training by surrounding drivers, by ensuring that the AV can operate safely, in a way that is evident, logical, or familiar to surrounding drivers and pedestrians.

During operation, AVs may be equipped with a local in-vehicle control computer capable of determining one or more AV operations. The AV may also provide data to an operation server which may in turn, provide instructions and/or supplementary instructions to the AV.

### SUMMARY

In general, embodiments of the present invention provide methods, apparatus, systems, computing devices, computing entities, and/or the like that allow for an AV to dynamically allocate communication network resources. For example, certain embodiments of the present invention utilize systems, methods, and computer program products that determine a data transmission prioritization policy regarding the transmission of auxiliary data and in turn, cause the transmission of an auxiliary data object of the auxiliary data.

In accordance with one aspect, a control subsystem of an autonomous vehicle is provided. The control subsystem may comprise processing circuitry that is configured to determine a measure of auxiliary communication network resource availability associated with auxiliary data. The processing circuitry may further be configured to determine a data transmission prioritization policy that: a) describes one or more policies regarding the transmission of the auxiliary data and b) is determined based at least in part on or more operational states associated with the AV. The processing circuitry may further be configured to cause an auxiliary data object of the auxiliary data to be transmitted from the AV, wherein the auxiliary data object is generated based at least in part on the data transmission prioritization policy.

In some embodiments, the processing circuitry may further be configured to determine a measure of overall communication network resource availability available to the AV. The processing circuitry may further be configured to determine a measure of mandatory communication network resource availability associated with mandatory data. The processing circuitry may further be configured to determine the measure of auxiliary communication network resource availability associated with the auxiliary data based at least in part on the measure of overall communication network resource availability and the measure of mandatory communication network resource availability.

In some embodiments, the processing circuitry may further be configured to receive one or more signals from one or more sensors carried by the AV. The processing circuitry may further be configured to determine one or more operational states for the AV based at least in part on the one or more received signals. The processing circuitry may further be configured to, in an instance the one or more determined operational states for the AV differ from one or more preceding operational states, update the data transmission prioritization policy.

In some embodiments, the processing circuitry may further be configured to receive one or more transmission type requests that comprise one or more requests for auxiliary data. The processing circuitry may further be configured to update the data transmission prioritization policy based at least in part on the one or more transmission type requests.

In accordance with another aspect, a computer program product is provided. The computer program product may comprise at least one non-transitory computer-readable storage medium having computer-executable program code instructions stored therein, the computer-executable program code instructions comprising program code instructions configured to determine a measure of auxiliary communication network resource availability associated with auxiliary data. The computer-executable program code instructions comprising program code instructions may further be configured to determine a data transmission prioritization policy that: a) describes one or more policies regarding the transmission of the auxiliary data and b) is determined based at least in part on or more operational states associated with the AV. The computer-executable program code instructions comprising program code instructions may further be configured to cause an auxiliary data object of the auxiliary data to be transmitted from the AV, wherein the auxiliary data object is generated based at least in part on the data transmission prioritization policy.

In some embodiments, the computer-executable program code instructions comprising program code instructions may further be configured to determine a measure of overall communication network resource availability available to the AV. The computer-executable program code instructions comprising program code instructions may further be configured to determine a measure of mandatory communication network resource availability associated with mandatory data. The computer-executable program code instructions comprising program code instructions may further be configured to determine the measure of auxiliary communication network resource availability associated with the auxiliary data based at least in part on the overall measure of communication network resource availability and the measure of mandatory communication network resource availability.

In some embodiments, the computer-executable program code instructions comprising program code instructions may further be configured to receive one or more signals from one or more sensors carried by the AV. The computer-executable program code instructions comprising program code instructions may further be configured to determine one or more operational states for the AV based at least in part on the one or more received signals. The computer-executable program code instructions comprising program code instructions may further be configured to, in an instance the one or more determined operational states for the AV differ from one or more preceding operational states, update the data transmission prioritization policy.

In some embodiments, the computer-executable program code instructions comprising program code instructions may further be configured to receive one or more transmission type requests that comprise one or more requests for auxiliary data. The computer-executable program code instructions comprising program code instructions may further be configured to update the data transmission prioritization policy based at least in part on the one or more transmission type requests.

In accordance with another aspect, a method is provided. The method may include determining a measure of auxiliary communication network resource availability associated with auxiliary data. The method may further include determining a data transmission prioritization policy that: a) describes one or more policies regarding the transmission of the auxiliary data and b) is determined based at least in part on or more operational states associated with the AV. The method may further include causing an auxiliary data object of the auxiliary data to be transmitted from the AV, wherein the auxiliary data object is generated based at least in part on the data transmission prioritization policy.

In some embodiments, the method may further include determining a measure of overall communication network resource availability available to the AV. The method may further include determining a measure of mandatory communication network resource availability associated with mandatory data. The method may further include determining the measure of auxiliary communication network resource availability associated with the auxiliary data based at least in part on the measure of overall communication network resource availability and the measure of mandatory communication network resource availability.

In some embodiments, the method may further include receiving one or more signals from one or more sensors carried by the AV. The method may further include determining one or more operational states for the AV based at least in part on the one or more received signals. The method may further include, in an instance the one or more determined operational states for the AV differ from one or more preceding operational states, updating the data transmission prioritization policy.

In some embodiments, the method may further include receiving one or more transmission type requests that comprise one or more requests for auxiliary data. The method may further include updating the data transmission prioritization policy based at least in part on the one or more transmission type requests.

In accordance with another aspect, an apparatus is provided. The apparatus may be configured with means for determining a measure of auxiliary communication network resource availability associated with auxiliary data. The apparatus may be configured with means for determining a data transmission prioritization policy that: a) describes one or more policies regarding the transmission of the auxiliary data and b) is determined based at least in part on or more operational states associated with the AV. The apparatus may be configured with means for causing an auxiliary data object of the auxiliary data to be transmitted from the AV, wherein the auxiliary data object is generated based at least in part on the data transmission prioritization policy.

In some embodiments, the apparatus may be configured with means for determining a measure of overall communication network resource availability available to the AV. The apparatus may be configured with means for determining a measure of mandatory communication network resource availability associated with mandatory data. The apparatus may be configured with means for determining the measure of auxiliary communication network resource availability associated with the auxiliary data based at least in part on the measure of overall communication network resource availability and the measure of mandatory communication network resource availability.

In some embodiments, the apparatus may be configured with means for receiving one or more signals from one or more sensors carried by the AV. The apparatus may be configured with means for determining one or more operational states for the AV based at least in part on the one or more received signals. The apparatus may be configured with means for, in an instance the one or more determined operational states for the AV differ from one or more preceding operational states, updating the data transmission prioritization policy.

In some embodiments, the apparatus may be configured with means for receiving one or more transmission type requests that comprise one or more requests for auxiliary data. The apparatus may be configured with means for updating the data transmission prioritization policy based at least in part on the one or more transmission type requests.

In some embodiments, the data transmission prioritization policy at least describes a data pre-processing policy indicative of how data should be processed prior to being transmitted from the AV. In some embodiments, the data transmission prioritization policy at least describes one or more data types associated with the auxiliary data to be transmitted from the AV. In some embodiments, the data transmission prioritization policy at least describes a frequency for which the auxiliary data is to be transmitted from the AV. In some embodiments, the one or more operational states describe one or more of environmental operating conditions, driving events, AV operating conditions, or navigational operating conditions. In some embodiments, a data transmission prioritization machine learning model is used to determine the data transmission prioritization policy.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an example communication system that can be used to practice embodiments of the present invention.

FIG. 2 illustrates a block diagram of a control subsystem in accordance with some embodiments discussed herein;

FIG. 3 illustrates a block diagram of an operation server in accordance with some embodiments discussed herein;

FIG. 4 illustrates a diagram of an example autonomous vehicle configured to implement autonomous driving operations in accordance with some embodiments discussed herein;

FIG. 5 illustrates a diagram of an in-vehicle control computer included in an AV in accordance with some embodiments discussed herein;

FIG. 6 is a flowchart diagram of an example process for allocating communication network resources in accordance with some embodiments discussed herein; and

FIG. 7 is a flowchart diagram of an example process for updating a data transmission prioritization policy in accordance with some embodiments discussed herein.

### DETAILED DESCRIPTION

Conventionally, data transmission may be determined based at least in part on quality of service (QoS) parameters, which can be determined based at least in part on a packet loss, bit rate, throughput, transmission delay, availability, jitter, etc. associated with the data transmission. However, embodiments of the present invention contemplate the determination of data transmission based at least in part on overall communication network resource availability (e.g., bandwidth) without the need to consider the QoS associated with said data transmission. This allows for simpler determinations regarding the transmission of data and thus, allows for decreased latency and overall bandwidth usage when transmitting the data. In particular, embodiments of the present invention contemplate the transmission of mandatory data and auxiliary data based at least in part on the overall communication network resource availability and using a data transmission prioritization policy. The data transmission prioritization policy, which may define one or more policies regarding the transmission of auxiliary data, may be determined based at least in part on one or more operational states associated with an AV. In some embodiments, a data transmission prioritization machine learning model may be used to determine the data transmission prioritization policy, such as by using one or more weighted combinations of the one or more operational states corresponding to the AV. An auxiliary data object of the auxiliary data may then be transmitted from the AV based at least in part on the data transmission prioritization policy. As such, an AV may utilize the auxiliary bandwidth network resource availability to provide one or more computing entities with auxiliary data determined to have the highest inferred importance based at least in part on one or more current operational states of the AV.

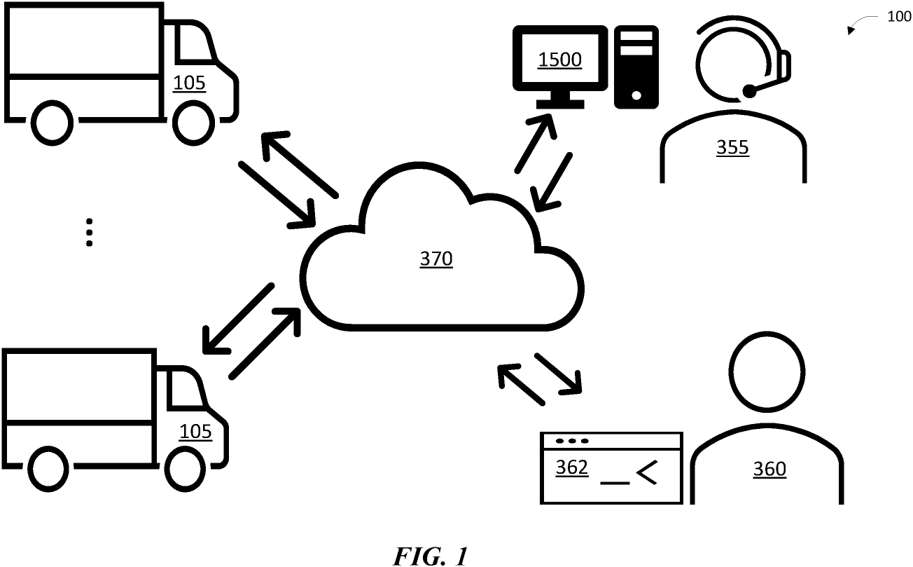

FIG. 1 illustrates an example system 100 that includes one or more AVs 105, an operation server 1500 with a human operator 355, and an interface 362 for third-party 360 interaction. A human operator 355 may also be known as a remoter center operator (RCO). Communications between the AVs 105, operation server 1500 and user interface 362 take place over a network 370. In some instances, where not all the AVs 105 in a fleet are able to communicate with the operation server 1500, the AVs 105 may communicate with each other over the network 370 or directly. Each AV 105 may include an in-vehicle control computer (VCU) which enables a module for network communications. In some embodiments, an AV 105 may be a semi-truck tractor unit that attaches to a trailer to transport cargo or freight. However, as will be appreciated by one of skill in the art, the AV 105 may be embodied by any autonomous vehicle such as a car, truck, drone, water vessel, and/or the like.

An autonomous vehicle may be in communication with an operation server. The operation server may serve many purposes, including: tracking the progress of one or more autonomous vehicles (e.g., an autonomous truck), tracking the progress of a fleet of autonomous vehicles; sending maneuvering instructions to one or more autonomous vehicles; monitoring the health of the autonomous vehicle(s), monitoring the status of the cargo of each autonomous vehicle in contact with the operation server, facilitate communications between third parties (e.g., law enforcement, clients whose cargo is being carried) and each, or a specific, autonomous vehicle; allow for tracking of specific autonomous trucks in communication with the operation server (e.g., third-party tracking of a subset of vehicles in a fleet), arranging maintenance service for the autonomous vehicles (e.g., oil changing, fueling, maintaining the levels of other fluids), alerting an affected autonomous vehicle of changes in traffic or weather that may adversely impact a route or delivery plan, pushing over the air updates to autonomous trucks to keep all components up to date, and other purposes or functions that improve the safety for the autonomous vehicle, its cargo, and/or its surroundings. An operation server may also determine performance parameters of an autonomous vehicle or autonomous truck, including any of: data logging frequency, compression rate, location, data type; communication prioritization; how frequently to service the autonomous vehicle (e.g., how many miles between services); when to perform a minimal risk condition (MRC) maneuver while monitoring the vehicle’s progress during the maneuver; when to hand over control of the autonomous vehicle to a human driver (e.g., at a destination yard); ensuring an autonomous vehicle passes pre-trip inspection; ensuring an autonomous vehicle performs or conforms to legal requirements at checkpoints and weight stations; ensuring an autonomous vehicle performs or conforms to instructions from a human at the site of a roadblock, cross-walk, intersection, construction, or accident; and/or the like.

To allow for communication between autonomous vehicles in a fleet and an operation server or command center, each autonomous vehicle may be equipped with a communication gateway. The communication gateway may have the ability to do any of the following: allow for AV to operation server communication (i.e. V2C) and the operation server to AV communication (C2V); allow for AV to AV communication within the fleet (V2V); transmit the availability or status of the communication gateway; acknowledge received communications; ensure security around remote commands between the AV and the operation server; convey the AV’s location reliably at set time intervals; enable the operation server to ping the AV for location and vehicle health status; allow for streaming of various sensor data directly to the command or operation server; allow for automated alerts between the AV and operation server; comply to International Organization for Standardization (ISO) 21434 standards; and the like.

An operation server or command center may be operated by one or more human, also known as an operator and/or a remote center operator. The operator may set thresholds for autonomous vehicle health parameters, so that when an autonomous vehicle meets or exceeds the threshold, precautionary action may be taken. Examples of vehicle health parameters for which thresholds may be established by an operator may include any of: fuel levels; oil levels; miles traveled since last maintenance; low tire-pressure detected; cleaning fluid levels; brake fluid levels; responsiveness of steering and braking subsystems; Diesel exhaust fluid (DEF) level; communication ability (e.g., lack of responsiveness); positioning sensors ability (e.g., GPS, IMU malfunction); impact detection (e.g., vehicle collision); perception sensor ability (e.g., camera, LIDAR, radar, microphone array malfunction); computing resources ability (e.g., VCU or ECU malfunction or lack of responsiveness, temperature abnormalities in computing units); angle between a tractor and trailer in a towing situation (e.g., tractor-trailer, 18-wheeler, or semi-truck); unauthorized access by a living entity (e.g., a person or an animal) to the interior of an autonomous truck; and the like. The precautionary action may include execution of a minimal risk condition (MRC) maneuver, seeking service, or exiting a highway or other such re-routing that may be less taxing on the autonomous vehicle. An autonomous vehicle whose system health data meets or exceeds a threshold set at the operation server or by the operator may receive instructions that are automatically sent from the operation server to perform the precautionary action.

The operator may be made aware of situations affecting one or more autonomous vehicles in communication with or being monitored by the operation server that the affected autonomous vehicle(s) may not be aware of. Such situations may include: irregular or sudden changes in traffic flow (e.g., traffic jam or accident); abrupt weather changes; abrupt changes in visibility; emergency conditions (e.g., fire, sink-hole, bridge failure); power outage affecting signal lights; unexpected road work; large or ambiguous road debris (e.g., object unidentifiable by the autonomous vehicle); law enforcement activity on the roadway (e.g., car chase or road clearing activity); and the like. These types of situations that may not be detectable by an autonomous vehicle may be brought to the attention of the operation server operator through traffic reports, law enforcement communications, data from other vehicles that are in communication with the operation server, reports from drivers of other vehicles in the area, and similar distributed information venues. An autonomous vehicle may not be able to detect such situations because of limitations of sensor systems or lack of access to the information distribution means (e.g., no direct communication with weather agency). An operator at the operation server may push such information to affected autonomous vehicles that are in communication with the operation server. The affected autonomous vehicles may proceed to alter their route, trajectory, or speed in response to the information pushed from the operation server. In some instances, the information received by the operation server may trigger a threshold condition indicating that MRC (minimal risk condition) maneuvers are warranted; alternatively, or additionally, an operator may evaluate a situation and determine that an affected autonomous vehicle should perform an MRC maneuver and subsequently send such instructions to the affected vehicle. In these cases, each autonomous vehicle receiving either information or instructions from the operation server or the operation server operator uses its on-board computing unit (i.e. VCU) to determine how to safely proceed, including performing an MRC maneuver that includes pulling-over or stopping.

An operation server or command center may allow a third party to interact with the operation server operator, with an autonomous truck, or with both the human system operator and an autonomous truck. A third party may be a customer whose goods are being transported, a law enforcement or emergency services provider, or a person assisting the autonomous truck when service is needed. In its interaction with a third party, the operation server may recognize different levels of access, such that a customer concerned about the timing or progress of a shipment may only be allowed to view status updates for an autonomous truck, or may be able to view status and provide input regarding what parameters to prioritize (e.g., speed, economy, maintaining originally planned route) to the operation server. By providing input regarding parameter prioritization to the operation server, a customer can influence the route and/or operating parameters of the autonomous truck.

### Exemplary Control Subsystem

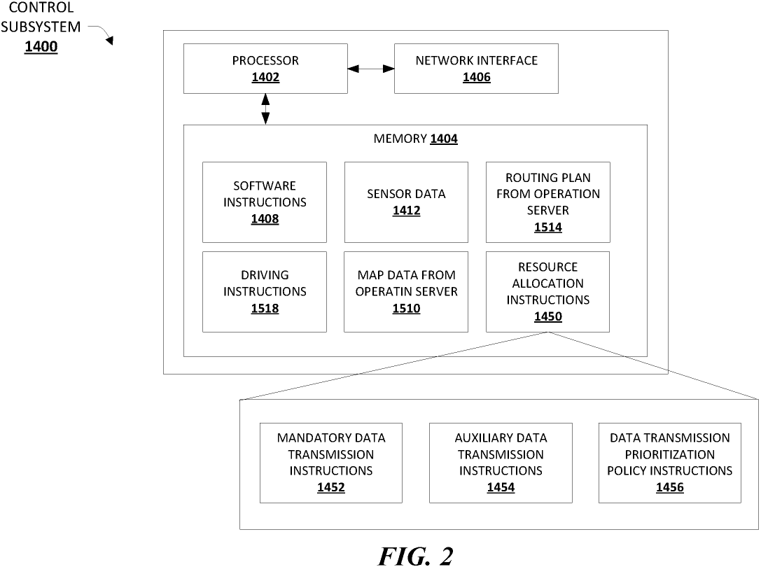

FIG. 2 illustrates an embodiment of the control subsystem 1400. The control subsystem 1400 includes at least one processor 1402, at least one memory 1404, and at least one network interface 1406. The control subsystem 1400 may be configured as shown or in any other suitable configuration.

The processor 1402 may comprise one or more processors operably coupled to the memory 1404. The processor 1402 is any electronic circuitry including, but not limited to, state machines, one or more central processing unit (CPU) chips, logic units, cores (e.g. a multi-core processor), field-programmable gate array (FPGAs), application specific integrated circuits (ASICs), or digital signal processors (DSPs). The processor 1402 may be a programmable logic device, a microcontroller, a microprocessor, or any suitable combination of the preceding. The processor 1402 is communicatively coupled to and in signal communication with the memory 1404 and the network interface 1406. The one or more processors are configured to process data and may be implemented in hardware or software. For example, the processor 1402 may be 8-bit, 16-bit, 32-bit, 64-bit or of any other suitable architecture. The processor 1402 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The one or more processors are configured to implement various instructions. For example, the one or more processors are configured to execute instructions to implement the functions disclosed herein, such as some or all of those described with respect to FIGS. 1-13. In some embodiments, the function described herein is implemented using logic units, FPGAs, ASICs, DSPs, or any other suitable hardware or electronic circuitry.

The memory 1404 is operable to store any of the information described below along with any other data, instructions, logic, rules, or code operable to implement the function(s) described herein when executed by processor 1402. For example, the memory 1404 may store software instructions 1408, sensor data 1412 received from the sensors 1646, drive subsystem 1642, and/or control subsystem 1648 of the AV 105, map data 1510, routing plan 1514, driving instructions 1518, and/or any other data/instructions described herein. The memory 1404 may further store resource allocation instructions 1450, which may be configured to determine mandatory data transmission instructions 1452, auxiliary data transmission instructions 1454, data transmission prioritization policy instructions 1456. The memory 1404 comprises one or more disks, tape drives, or solid-state drives, and may be used as an over-flow data storage device, to store programs when such programs are selected for execution, and to store instructions and data that are read during program execution. The memory 1404 may be volatile or non-volatile and may comprise read-only memory (ROM), random-access memory (RAM), ternary content-addressable memory (TCAM), dynamic random-access memory (DRAM), and static random-access memory (SRAM).

The network interface 1406 is configured to enable wired and/or wireless communications. The network interface 1406 is configured to communicate data between the control subsystem 1400 and other network devices, systems, or domain(s). For example, the network interface 1406 may comprise a WIFI interface, a local area network (LAN) interface, a wide area network (WAN) interface, a modem, a switch, or a router. The processor 1402 is configured to send and receive data using the network interface 1406. The network interface 1406 may be configured to use any suitable type of communication protocol.

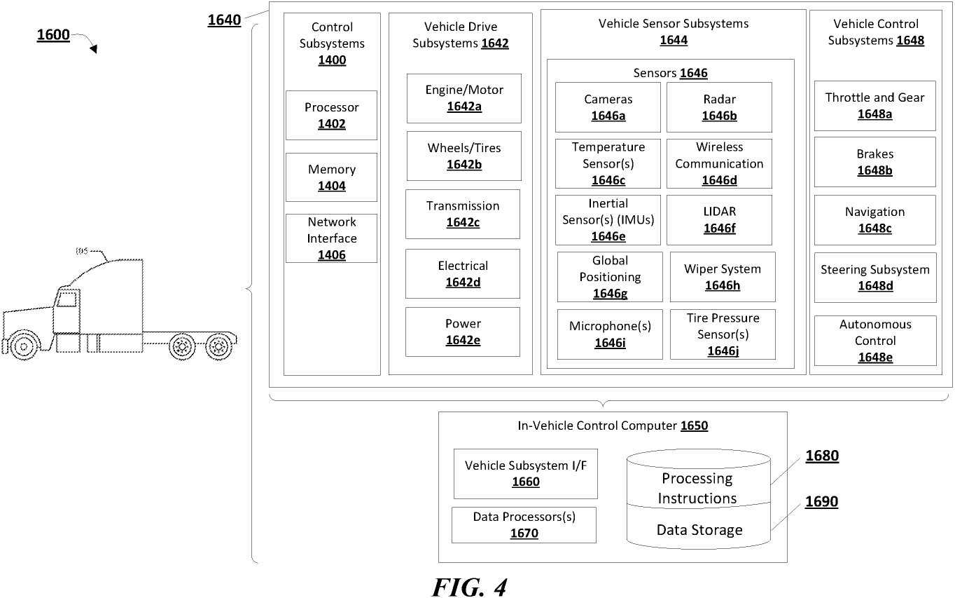

In one embodiment, the control subsystem 1400 may be a subsystem of the in-vehicle control computer system 1650 (See FIG. 4). The control subsystem 1400 may be implemented by one or more computing devices that may serve to determine a data transmission prioritization policy and/or control the transmission of mandatory data and/or auxiliary data. The control subsystem 1400 is in signal communication with the in-vehicle control computer system 1650 (and its components) and the operation server 1500.

In some embodiments, the mandatory data transmission instructions 1452 may be configured to provide instructions regarding the transmission of mandatory data from the AV 105. The instructions may be indicative of which mandatory data to transmit, data pre-processing policy indicative of how mandatory data should be processed prior to being transmitted from the AV 105, a frequency for which the mandatory data is to be transmitted from the AV 105, receiving computing entities (e.g., operation server 1500), and/or the like. The mandatory data transmission instructions 1454 may be configured to cause a mandatory data object of mandatory data to be transmitted from the AV 105 to one or more computing entities, such as operation server 1500.

In some embodiments, the auxiliary data transmission instructions 1454 may be configured to provide instructions regarding the transmission of auxiliary data from the AV 105. The instructions may be indicative of which auxiliary data to transmit, data pre-processing policy indicative of how auxiliary data should be processed prior to being transmitted from the AV 105, a frequency for which the auxiliary data is to be transmitted from the AV 105, receiving computing entities (e.g., operation server 1500), a measure of auxiliary communication network resource availability, and/or the like. The auxiliary data transmission instructions 1454 may be configured to cause an auxiliary data object of auxiliary data to be transmitted from the AV 105 to one or more computing entities, such as operation server 1500.

In some embodiments, data transmission prioritization policy instructions 1456 may be configured to provide instructions regarding the determination of a data transmission prioritization policy. For example, the data transmission prioritization policy instructions 1456 may provide instructions regarding the determination of a one or more operational states associated with the AV 105, generation of the data transmission prioritization policy, updating of the transmission prioritization policy, and/or the like. The data transmission prioritization policy may be used by the auxiliary data transmission instructions 1454 with regard to the transmission of auxiliary data.

### Example Operation Server 1500

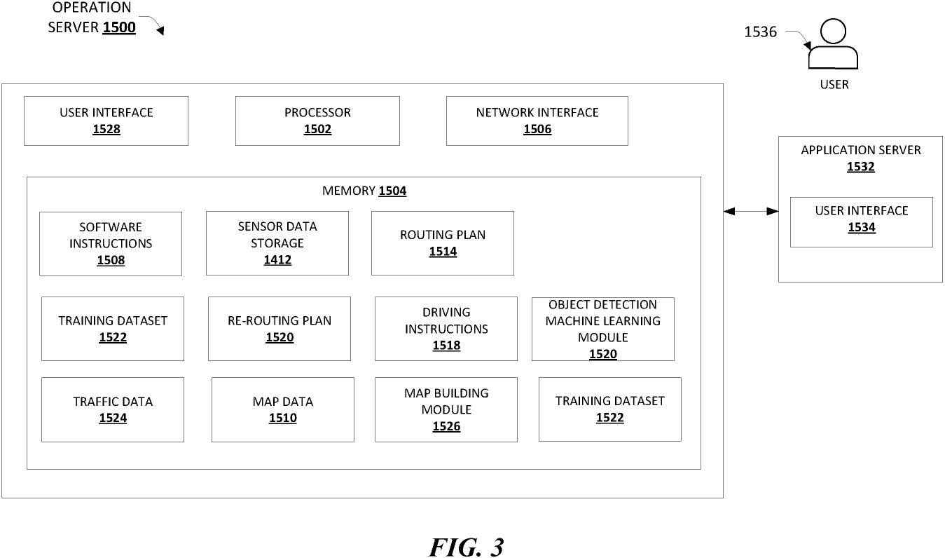

FIG. 3 shows an embodiment of the operation server 1500. The operation server 1500 includes at least one processor 1502, at least one memory 1504, and at least one network interface 1506. The operation server 1500 may be configured as shown or in any other suitable configuration.

The processor 1502 comprises one or more processors operably coupled to the memory 1504. The processor 1502 is any electronic circuitry including, but not limited to, state machines, one or more central processing unit (CPU) chips, logic units, cores (e.g. a multi-core processor), field-programmable gate array (FPGAs), application specific integrated circuits (ASICs), or digital signal processors (DSPs). The processor 1502 may be a programmable logic device, a microcontroller, a microprocessor, or any suitable combination of the preceding. The processor 1502 is communicatively coupled to and in signal communication with the memory 1504, the network interface 1506, and user interface 1528. The one or more processors are configured to process data and may be implemented in hardware or software. For example, the processor 1502 may be 8-bit, 16-bit, 32-bit, 64-bit or of any other suitable architecture. The processor 1502 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The one or more processors are configured to implement various instructions. For example, the one or more processors are configured to execute instructions to implement the function disclosed herein, such as some or all of those described with respect to FIGS. 1-13. In some embodiments, the function described herein is implemented using logic units, FPGAs, ASICs, DSPs, or any other suitable hardware or electronic circuitry.

The memory 1504 is operable to store any of the information described below along with any other data, instructions, logic, rules, or code operable to implement the function(s) described herein when executed by processor 1502. For example, the memory 1504 may store software instructions 1508, map data 1510, re-routing plans 1520, routing plan 1514, training dataset 1522, driving instructions 1518, sensor data 1412 received from the AVs 1602, traffic data 1524, map building module 1526, and/or any other data/instructions. The memory 1504 comprises one or more disks, tape drives, or solid-state drives, and may be used as an over-flow data storage device, to store programs when such programs are selected for execution, and to store instructions and data that are read during program execution. The memory 1504 may be volatile or non-volatile and may comprise read-only memory (ROM), random-access memory (RAM), ternary content-addressable memory (TCAM), dynamic random-access memory (DRAM), and static random-access memory (SRAM).

The network interface 1506 is configured to enable wired and/or wireless communications. The network interface 1506 is configured to communicate data between the control subsystem 1400 and other network devices, systems, or domain(s). For example, the network interface 1506 may comprise a WIFI interface, a local area network (LAN) interface, a wide area network (WAN) interface, a modem, a switch, or a router. The processor 1502 is configured to send and receive data using the network interface 1506. The network interface 1506 may be configured to use any suitable type of communication protocol.

In one embodiment, the operation server 1500 may be implemented by a cluster of computing devices that may serve to oversee the operations of the AV 105. For example, the operation server 1500 may be implemented by a plurality of computing devices using distributed computing and/or cloud computing systems. In another example, the operation server 1500 may be implemented by a plurality of computing devices in one or more data centers. The operation server 1500 is in signal communication with the AV 105 and its components (e.g., the in-vehicle control computer 1650). In one embodiment, the operation server 1500 is configured to determine a particular routing plan 1514 for each AV 105. For example, the operation server 1500 may determine a particular routing plan 1514 for an AV 105 that leads to reduced driving time and a safer driving experience for reaching the destination of that AV 105. In one embodiment, the operation server 1500 may capture and record the navigation plans set by the user 1536 in each situation and use it in similar situations.

In one embodiment, the operation server 1500 may send the sensor data 1412 to an application server 1532 to be reviewed by users 1536. The application server 1532 is generally any computing device configured to communicate with other devices, such as other servers (e.g., operation server 1500), AV 105, databases, etc., via a network interface. The application server 1532 is configured to perform specific functions described herein and interact with users 1536, e.g., via its user interfaces 1534. Examples of the application server 1532 include but are not limited to desktop computers, laptop computers, servers, etc. In one example, the application server 1532 may act as a presentation layer where users 1536 access to review the sensor data 1412. As such, the operation server 1500 may send the sensor data 1412 to an application server 1532. The user 1536 may review the sensor data 1412 from the user interface 1534 and confirm, modify, and/or override navigating solutions for the AVs 105 determined by the control subsystem 1400 and/or the operation server 1500, such as described above.

Map data 1510 may include a virtual map of a city which includes a route. In some examples, the map data 1510 may include one or more map databases. The map data 1510 may include drivable areas, such as roads, paths, highways, and undrivable areas, such as terrain. The map data 1510 may specify location coordinates of road signs, lanes, lane markings, lane boundaries, road boundaries, traffic lights, etc.

The map data 1510 may also specify connections between lanes (e.g., which lanes can feed into other adjacent lanes). The map data 1510 may specify information indicating types of lanes of a road (e.g., traffic lane, passing lane, emergency lane, turning lane, bus lane, etc.), types of lane boundaries (e.g., white lines, yellow lines, other road surface markings and/or mechanical markings, etc.), types of road boundaries (e.g., regular curbs, red curbs, sidewalks, guard rails, other barriers, etc.) road intersections, one or more obstacles ahead of the autonomous vehicle, and other information about the road or areas adjacent to the road. The map data 1510 may also specify elevations of roads, such as curves, hills, valleys; road hazards, such as speed bumps, potholes; road sections, such as road school zones, railroad crossings, etc.

Map building module 1526 may be implemented by the processor 1502 executing software instructions 1508, is configured to build the map data 1510. In one embodiment, the map building module 1526 may build the map data 1510 from sensor data received from one or more mapping vehicles. In one example, a mapping vehicle may be an AV 105. In another example, a mapping vehicle may be an AV 105 or un-autonomous vehicle connected or integrated with sensors 1646 operated by a driver. In some cases, one or more mapping vehicles may be dispatched to observe a situation detected by an AV 105, such as via the mandatory and/or auxiliary data transmitted from AV 105, and send more sensor data related to the situation.

The map building module 1526 is configured to use the sensor data to determine which portion of the map data 1510 they are associated with. The map building module 1526 may dynamically build each section of the map data 1510 by merging different sensor data associated with each section of the map data 1510. The map building module 1526 also uses the sensor data to discover overlapping portions of the map data 1510 (e.g., by matching corresponding images, videos, LiDAR data, radar data, etc. observing the same portion of the map data 1510). The map building module 1526 then connects portions of the map data 1510 with their corresponding adjacent portions. In other words, the map building module 1526 discovers adjacent portions of the map data 1510, stitches them together, and builds the map data 1510. The map building module 1526 is also configured to update a portion of the map data 1510 that based at least in part on the received sensor data needs to be updated.

For example, in the case of an unknown object in a roadway, when the operation server 1500 receives the sensor data from the AV 105 via mandatory data transmission and/or auxiliary data transmission, once it is confirmed that there is indeed an unknown object at particular location coordinates, the map building module 1526 updates a portion of the map data 1510, reflecting the presence of the unknown object. Similarly, the map building module 1526 updates different portions of the map data 1510 based at least in part on sensor data related to different cases of encountering unexpected situations.

The map building module 1526 is also configured to facilitate shadow testing of routing plans 1514 using the new layout of one or more roads in the updated map data 1510. For example, when the map data 1510 is updated, the map building module 1526 may run one or more simulations of autonomous driving through the updates map data 1510 for the AV 105. For example, the one or more simulations of autonomous driving may be related to the AV 105 navigating around an object, changing lanes, pulling over, re-routing, etc.

The map building module 1526 selects a particular of course of autonomous driving from the one or more simulations of autonomous driving that leads to a more efficient, safe, and reliable navigating solution for each AV 105 compared to other simulations.

Routing plan 1514 is a plan for traveling from a start location (e.g., a first AV launch pad/landing pad) to a destination (e.g., a second AV launchpad/landing pad). For example, the routing plan 1514 of the AV 105 may specify a combination of one or more streets/roads/highways in a specific order from the start location to the destination. The routing plan 1514 of the AV 105 may specify stages including the first stage (e.g., moving out from the start location), a plurality of intermediate stages (e.g., traveling along particular lanes of one or more particular street/road/highway), and the last stage (e.g., entering the destination. The routing plan 1514 may include other information about the route from the start position to the destination, such as road/traffic signs in that routing plan 1514, etc.

The driving instructions 1518 may include instructions and rules to adapt the autonomous driving of the AV 105 according to the driving rules of each stage of the routing plan 1514. For example, the driving instructions 1518 may include instructions to stay within the speed range of a road traveled by the AV 105, adapt the speed of the AV 105 with respect to observed changes by the sensors 1646, such as speeds of surrounding vehicles, objects within the detection zones of the sensors, etc.

Object detection machine learning modules 1520 may be implemented by the processor 1502 executing software instructions 1508, and is generally configured to detect objects from the sensor data 1412. The object detection machine learning modules 1520 may be implemented using neural networks and/or machine learning algorithms for detecting objects from any data type, such as images, videos, infrared images, point clouds, radar data, etc.

In one embodiment, the object detection machine learning modules 1520 may be implemented using machine learning algorithms, such as Support Vector Machine (SVM), Naive Bayes, Logistic Regression, k-Nearest Neighbors, Decision trees, or the like. In one embodiment, the object detection machine learning modules 1520 may utilize a plurality of neural network layers, convolutional neural network layers, and/or the like, in which weights and biases of perceptrons of these layers are optimized in the training process of the object detection machine learning modules 1520. The object detection machine learning modules 1520 may be trained by the training dataset 1522 which includes samples of data types labeled with one or more objects in each sample. For example, the training dataset 1522 may include sample images of objects (e.g., vehicles, lane markings, pedestrian, road signs, etc.) labeled with object(s) in each sample image. Similarly, the training dataset 1522 may include samples of other data types, such as videos, infrared images, point clouds, radar data, etc. labeled with object(s) in each sample data. The object detection machine learning modules 1520 may be trained, testes, and refined by the training dataset 1522 and the sensor data 1412. The object detection machine learning modules 1520 uses the sensor data 1412 (which are not labeled with objects) to increase their accuracy of predictions in detecting objects. For example, supervised and/or unsupervised machine learning algorithms may be used to validate the predictions of the object detection machine learning modules 1520 in detecting objects in the sensor data 1412.

Traffic data 1524 may include traffic data 1524 of roads/streets/highways in the map data 1510. The operation server 1500 may use traffic data 1524 gathered by one or more mapping vehicles. The operation server 1500 may use traffic data 1524 that is captured from any source, such as crowd-sourced traffic data 1524 captured from external sources, e.g., Waze and Google map, live traffic reporting, etc.

### Example AV 105 and Its Operation

FIG. 4 shows a block diagram of an example vehicle ecosystem 1600 in which autonomous driving operations can be determined. As shown in FIG. 16, the AV 105 may be a semi-trailer truck. The vehicle ecosystem 1600 includes several systems and components that can generate and/or deliver one or more sources of information/data and related services to the in-vehicle control computer 1650 that may be located in an AV 105. The in-vehicle control computer 1650 can be in data communication with a plurality of vehicle subsystems 1640, all of which can be resident in the AV 105. A vehicle subsystem interface 1660 is provided to facilitate data communication between the in-vehicle control computer 1650 and the plurality of vehicle subsystems 1640. In some embodiments, the vehicle subsystem interface 1660 can include a controller area network (CAN) controller to communicate with devices in the vehicle subsystems 1640.

The AV 105 may include various vehicle subsystems that support of the operation of AV 105. The vehicle subsystems may include the control subsystem 1400, a vehicle drive subsystem 1642, a vehicle sensor subsystem 1644, and/or a vehicle control subsystem 1648. The components or devices of the vehicle drive subsystem 1642, the vehicle sensor subsystem 1644, and the vehicle control subsystem 1648 shown in FIG. 4 are examples. The vehicle drive subsystem 1642 may include components operable to provide powered motion for the AV 105. In an example embodiment, the vehicle drive subsystem 1642 may include an engine/motor 1642a, wheels/tires 1642b, a transmission 1642c, an electrical subsystem 1642d, and a power source 1642e.

The vehicle sensor subsystem 1644 may include a number of sensors 1646 configured to sense information about an environment or condition of the AV 105. The vehicle sensor subsystem 1644 may include one or more cameras 1646a, which may be equipped with microphones, or image capture devices, a radar unit 1646b, one or more temperature sensors 1646c, a wireless communication unit 1646d (e.g., a cellular communication transceiver), an inertial measurement unit (IMU) 1646e, a laser range finder/LiDAR unit 1646f, a Global Positioning System (GPS) transceiver 1646 g, a wiper control system 1646h, microphones 1646i, and/or tire pressure sensor(s) 1646j. The vehicle sensor subsystem 1644 may also include sensors configured to monitor internal systems of the AV 105 (e.g., an O2 monitor, a fuel gauge, an engine oil temperature, etc.).

The IMU 1646e may include any combination of sensors (e.g., accelerometers and gyroscopes) configured to sense position and orientation changes of the AV 105 based at least in part on inertial acceleration. The GPS transceiver 1646 g may be any sensor configured to estimate a geographic location of the AV 105. For this purpose, the GPS transceiver 1646 g may include a receiver/transmitter operable to provide information regarding the position of the AV 105 with respect to the Earth. The radar unit 1646b may represent a system that utilizes radio signals to sense objects within the local environment of the AV 105. In some embodiments, in addition to sensing the objects, the radar unit 1646b may additionally be configured to sense the speed and the heading of the objects proximate to the AV 105. The laser range finder or LiDAR unit 1646f may be any sensor configured to sense objects in the environment in which the AV 105 is located using lasers. The cameras 1646a may include one or more devices configured to capture a plurality of images of the environment of the AV 105. The cameras 1646a may be still image cameras or motion video cameras. In some embodiments, the cameras 1646a may be configured with one or more microphones to capture audio data. Additionally or alternatively, one or more microphones 1646i may be configured to capture audio data of the environment of the AV 105 and/or pertaining to the AV 105.

The vehicle control subsystem 1648 may be configured to control the operation of the AV 105 and its components. Accordingly, the vehicle control subsystem 1648 may include various elements such as a throttle and gear 1648a, a brake unit 1648b, a navigation unit 1648c, a steering system 1648d, and/or an autonomous control unit 1648e. The throttle 1648a may be configured to control, for instance, the operating speed of the engine and, in turn, control the speed of the AV 105. The gear 1648a may be configured to control the gear selection of the transmission. The brake unit 1648b can include any combination of mechanisms configured to decelerate the AV 105. The brake unit 1648b can use friction to slow the wheels in a standard manner. The brake unit 1648b may include an Anti-lock brake system (ABS) that can prevent the brakes from locking up when the brakes are applied. The navigation unit 1648c may be any system configured to determine a driving path or route for the AV 105. The navigation 1648c unit may additionally be configured to update the driving path dynamically while the AV 105 is in operation. In some embodiments, the navigation unit 1648c may be configured to incorporate data from the GPS transceiver 1646 g and one or more predetermined maps so as to determine the driving path for the AV 105. The steering system 1648d may represent any combination of mechanisms that may be operable to adjust the heading of AV 105 in an autonomous mode or in a driver-controlled mode.

The autonomous control unit 1648e may represent a control system configured to identify, evaluate, and avoid or otherwise negotiate potential obstacles or obstructions in the environment of the AV 105. In general, the autonomous control unit 1648e may be configured to control the AV 105 for operation without a driver or to provide driver assistance in controlling the AV 105. In some embodiments, the autonomous control unit 1648e may be configured to incorporate data from the GPS transceiver 1646 g, the radar 1646b, the LiDAR unit 1646f, the cameras 1646a, and/or other vehicle subsystems to determine the driving path or trajectory for the AV 105.

Many or all of the functions of the AV 105 can be controlled by the in-vehicle control computer 1650. The in-vehicle control computer 1650 may include at least one data processor 1670 (which can include at least one microprocessor) that executes processing instructions 1680 stored in a non-transitory computer readable medium, such as the data storage device 1690 or memory. The in-vehicle control computer 1650 may also represent a plurality of computing devices that may serve to control individual components or subsystems of the AV 105 in a distributed fashion. In some embodiments, the data storage device 1690 may contain processing instructions 1680 (e.g., program logic) executable by the data processor 1670 to perform various methods and/or functions of the AV 105.

The data storage device 1690 may contain additional instructions as well, including instructions to transmit data to, receive data from, interact with, or control one or more of the vehicle drive subsystem 1642, the vehicle sensor subsystem 1644, and the vehicle control subsystem 1648. The in-vehicle control computer 1650 can be configured to include a data processor 1670 and a data storage device 1090. The in-vehicle control computer 1650 may control the function of the AV 105 based at least in part on inputs received from various vehicle subsystems (e.g., the vehicle drive subsystem 1642, the vehicle sensor subsystem 1644, and the vehicle control subsystem 1648).

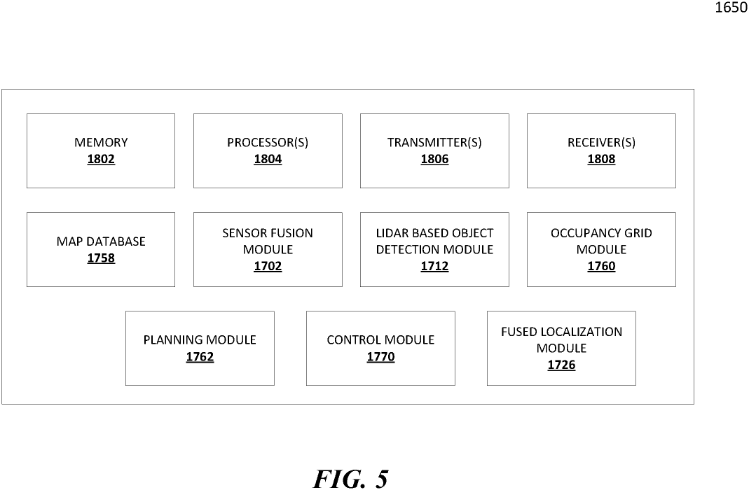

FIG. 5 shows an exemplary block diagram of an in-vehicle control computer 1650 included in an AV 105. The in-vehicle control computer 1650 includes at least one processor 1804 and a memory 1802 having instructions stored thereupon (e.g., software instructions 1408, 1508, and processing instructions 1680 in FIGS. 2, 3, and 4, respectively). The instructions upon execution by the processor 1804 configure the in-vehicle control computer 1650 and/or the various modules of the in-vehicle control computer 1650 to perform the operations described in FIGS. 2-4. The transmitter 1806 transmits or sends information or data to one or more devices in the autonomous vehicle. For example, a transmitter 1806 can send an instruction to one or more motors of the steering wheel to steer the autonomous vehicle. The receiver 1808 receives information or data transmitted or sent by one or more devices. For example, the receiver 1808 receives a status of the current speed from the odometer sensor or the current transmission gear from the transmission. The transmitter 1806 and receiver 1808 are also configured to communicate with the control subsystem 1400.

The in-vehicle control computer 1650 may include a sensor fusion module 1702, which may perform image or signal processing operations. The sensor fusion module 1702 can obtain images from cameras located on an autonomous vehicle to perform image segmentation to detect the presence of moving objects (e.g., other vehicles, pedestrians, etc.,) and/or static obstacles (e.g., stop sign, speed bump, terrain, etc.,) located around the autonomous vehicle. The sensor fusion module 1702 can obtain LiDAR point cloud data item from LiDAR sensors located on the autonomous vehicle to perform LiDAR segmentation to detect the presence of objects and/or obstacles located around the autonomous vehicle.

The sensor fusion module 1702 can perform instance segmentation on image and/or point cloud data item to identify an outline (e.g., boxes) around the objects and/or obstacles located around the autonomous vehicle. The sensor fusion module 1702 can perform temporal fusion where objects and/or obstacles from one image and/or one frame of point cloud data item are correlated with or associated with objects and/or obstacles from one or more images or frames subsequently received in time.

The sensor fusion module 1702 can fuse the objects and/or obstacles from the images obtained from the camera and/or point cloud data item obtained from the LiDAR sensors. For example, the sensor fusion module 1702 may determine based on a location of two cameras that an image from one of the cameras comprising one half of a vehicle located in front of the autonomous vehicle is the same as the vehicle located captured by another camera. The sensor fusion module 1702 sends the fused object information to the interference module 1746 and the fused obstacle information to the occupancy grid module 1760. The in-vehicle control computer includes the occupancy grid module 1760 can retrieve landmarks from a map database 1758 stored in the in-vehicle control computer. The occupancy grid module 1760 can determine drivable areas and/or obstacles from the fused obstacles obtained from the sensor fusion module 1702 and the landmarks stored in the map database 1758. For example, the occupancy grid module 1760 can determine that a drivable area may include a speed bump obstacle.

The in-vehicle control computer 1650 may also include a LiDAR based object detection module 1712 that can perform object detection 1716 based on point cloud data item obtained from the LiDAR sensors located on the AV 105. The object detection technique can provide a location (e.g., in 3D world coordinates) of objects from the point cloud data item. Below the LiDAR based object detection module 1712, the in-vehicle control computer may include an image based object detection module that can perform object detection based on images obtained from cameras located on the autonomous vehicle. The object detection technique can employ a deep machine learning technique to provide a location (e.g., in 3D world coordinates) of objects from the image provided by the camera.

The radar on the autonomous vehicle can scan an area in front of the autonomous vehicle or an area towards which the autonomous vehicle is driven. The radar data is sent to the sensor fusion module 1702 that can use the radar data to correlate the objects and/or obstacles detected by the radar with the objects and/or obstacles detected from both the LiDAR point cloud data item and the camera image.

The planning module 1762 can perform navigation planning 1764 to determine a set of trajectories on which the AV 105 can be driven. The set of trajectories can be determined based on the drivable area information, location of the obstacles, and the drivable area information. In some embodiments, the navigation planning may include determining an area next to the road where the autonomous vehicle can be safely parked in case of emergencies. The planning module 1762 may include behavioral decision making to determine driving actions (e.g., steering, braking, throttle) in response to determining changing conditions on the road (e.g., traffic light turned yellow, or the autonomous vehicle is in an unsafe driving condition because another vehicle drove in front of the autonomous vehicle and in a region within a pre-determined safe distance of the location of the autonomous vehicle). The planning module 1762 performs trajectory generation and selects a trajectory from the set of trajectories determined by the navigation planning operation. The selected trajectory information is sent by the planning module 1762 to the control module 1770.

The in-vehicle control computer includes a control module 1770 that receives the proposed trajectory from the planning module 1762 and the autonomous vehicle location and pose from the fused localization module 1726. The control module 1770 includes a system identifier. The control module 1770 can perform a model based trajectory refinement to refine the proposed trajectory. For example, the control module 1770 can applying a filtering (e.g., Kalman filter) to make the proposed trajectory data smooth and/or to minimize noise. The control module 1770 may perform the robust control by determining, based on the refined proposed trajectory information and current location and/or pose of the autonomous vehicle, an amount of brake pressure to apply, a steering angle, a throttle amount to control the speed of the vehicle, and/or a transmission gear. The control module 1770 can send the determined brake pressure, steering angle, throttle amount, and/or transmission gear to one or more devices in the autonomous vehicle to control and facilitate precise driving operations of the autonomous vehicle.

### Example Dynamic Allocation of Communication Network Resources

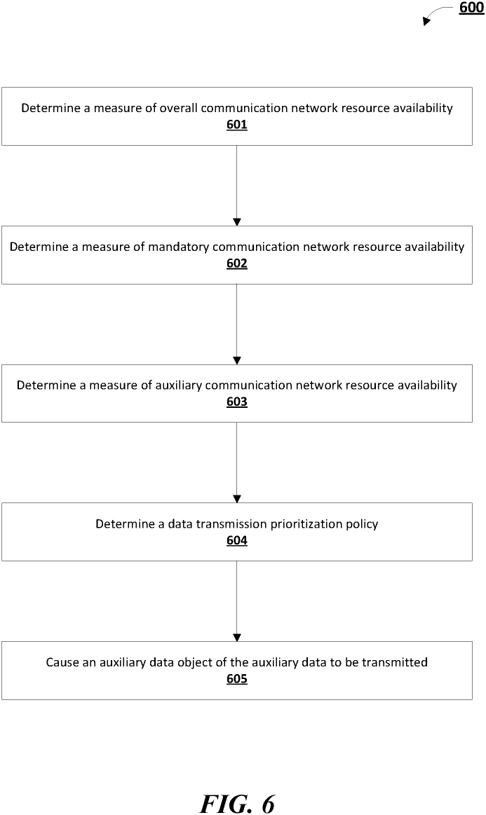

FIG. 6 illustrates a flow chart of an example method 600 for dynamically allocating communication network resources. The one or more of steps/operations depicted in FIG. 6 may be implemented, at least in part, in the form of software instructions 1408, 1508, and 1680 stored on non-transitory, tangible, machine-readable media (e.g., memories 1404, 1504, 1690, and 1802) that when run by one or more processors (e.g., processors 1402, 1502, 1670, and 1804) may cause the one or more processors to perform steps 601-605. In some embodiments, method 600 may be performed by control subsystem 1400, operation server 1500, and in-vehicle control computer 1650, respectively from FIGS. 2-5.

As shown in step/operation 601, an apparatus, such as control subsystem 1400, may include means such as processor 1402, memory 1404, network interface 1406, and/or the like for determining a measure of overall communication network resource availability. As described above, an AV 105 may be communicably coupled to one or more other computing entities (e.g., operation server 1500, one or more other AVs, one or more third-parties 360, etc.) via network 370. In some embodiments, the AV 105 may be communicably couple to one or more other computing entities using any suitable technologies, including but not limited to radio access networks, long term evolution advanced (LTE Advanced, LTE-A), a universal mobile telecommunications system (UMTS) radio access network (UTRAN or E-UTRAN), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile adhoc networks (MANETs) and Internet Protocol multimedia subsystems (IMS) or any combination thereof.

Regardless of the connection type, the processor 1402 may determine a measure of overall communication network resource availability for the current network connection type. For example, the measure of overall communication network resource availability may be a measure of the bandwidth available to the control subsystem 1400. In some embodiments, the measure of overall communication network resource availability may particularly refer to a measure of upload bandwidth availability.

Illustrative embodiments will be explained herein in the context of the Open System Interconnection model (OSI model) which is a model that conceptually characterizes communication functions of a communication system such as, for example, an LTE network. The OSI model is typically conceptualized as a hierarchical stack with a given layer serving the layer above and being served by the layer below. Typically, the OSI model comprises seven layers with the top layer of the stack being the application layer (layer 7) followed by the presentation layer (layer 6), the session layer (layer 5), the transport layer (layer 4), the network layer (layer 3), the data link layer (layer 2), and the physical layer (layer 1). One of ordinary skill in the art will appreciate the functions and interworkings of the various layers and, thus, further details of each layer are not described herein. However, it is to be appreciated that while illustrative embodiments are well-suited for implementations that utilize an OSI model, alternative embodiments are not necessarily limited to any particular communication function model.

The scheduling of overall communication network resource availability (e.g., available bandwidth) available to the control subsystem 1400 may occur within the application layer of network 370. In some embodiments, the control subsystem 1400 may request an indication of the overall communication network resource availability via network interface 1406. In some embodiments, the control subsystem 1400 may locally determine the overall communication network resource availability. The overall communication network resource availability may be based at least in part on one or more determination factors, such as a current network traffic load and/or a maximum resource allocation value as determined by a network subscription associated with the control subsystem 1400.

At step/operation 602, the apparatus, such as control subsystem 1400, may include means such as processor 1402, memory 1404, and/or the like for determining a measure of mandatory communication network resource availability. The measure of mandatory communication network resource availability may be based at least in part on associated mandatory data. Mandatory data may refer data which is required to be transmitted during AV 105 operations. For example, mandatory data may include certain sensor data (e.g., speed, location coordinates, etc.) associated with the AV 105. Mandatory data may, for example, be data associated with fundamental operation of the AV 105. Mandatory data may therefore be essential for the safe or effective operation of AV 105, such as data essential for performing a predetermined set of operations of the AV 105. The predetermined set of operations may thus be a set of operations essential for achieving a certain safety or operational standard. Other examples of mandatory data include data relating to the overall health of the vehicles communication systems (e.g. data to confirm such communication systems are functioning correctly), or data relating to the overall health of mechanical aspects of the vehicle (e.g. data to confirm no structural defects or issues) while the vehicle is in transit. Indeed, the determination of which data is mandatory may depend on the current status, operation or desired operation of the AV 105.

In some embodiments, control subsystem 1400 may be configured with a data categorization set which may define one or more data types as associated with a data category. The data categorization set may be a mapping of data categories to data types associated with the AV 105 associated with the control subsystem 1400, or vice versa. For example, one or more candidate data categories may include a mandatory data category and an auxiliary data category. A data type of ‘image data from camera 1’ may be defined as mandatory according to the data categorization set. As such, any data associated with the data type ‘image data from camera 1’ is determined to be mandatory data. In some embodiments, the categorization set may be determined and initialized based at least in part on user input, such as RCO 355.

The control subsystem 1400 may then determine the measure of mandatory communication network availability based at least in part on the aggregation of mandatory data to be transmitted. For example, the control subsystem 1400 may determine an associated data packet size for a data packet that contains the aggregated mandatory data. In some embodiments, the measure of mandatory communication network resource availability may refer to a measure of the upload bandwidth dedicated to the transmission of mandatory data. The measure of mandatory communication network resource availability may be regarded as a measure of communication network resource required for the AV 105 to perform the predetermined set of operations.

In some embodiments, the control subsystem 1400 may be configured to pre-process mandatory data according to a mandatory data pre-processing policy. The mandatory data pre-processing policy may define a process for pre-processing each mandatory data type in a particular way prior to causing the mandatory data to be provided to one or more additional computing entities. In some embodiments, the control subsystem 1400 may processor 1402 to perform one or more mandatory data pre-processing routines as defined by the mandatory data pre-processing policy such that the mandatory data may be formatted appropriately for transmission. For example, a pre-processing routine for any image data may convert raw images into one or more compressed images. As such, the data size associated with the mandatory data may be reduced.

At step/operation 603, the apparatus, such as control subsystem 1400, may include means such as processor 1402, memory 1404, and/or the like for determining a measure of auxiliary communication network resource availability. The measure of auxiliary communication network resource availability may be based at least in part on the overall communication network resource availability and the mandatory communication network resource availability as determined at step/operations 601 and 602, respectively. Auxiliary data may refer data which is optional for transmission during AV 105 operations. For example, auxiliary data may include sensor data (e.g., speed, location coordinates, etc.) associated with the AV 105 which is not classified as mandatory. Such optional, auxiliary data may therefore be data which is not essential for the safe operation of AV 105. In other words, the predetermined set of operations may still be performed by the AV 105 in the absence of the auxiliary data. Such auxiliary data, however, may nonetheless improve the performance of the AV 105 and may further increase safety, efficiency, responsiveness or another property of AV performance.

As described above, in some embodiments, control subsystem 1400 may be configured with a data categorization set which may define one or more data types as associated with a data category. The data categorization set defines data types which are classified as auxiliary data. For example, one or more candidate data categories may include a mandatory data category and an auxiliary data category. Whereas a data type of ‘image data from camera 1’ may be defined as a mandatory according to the data categorization set, a data type of ‘image data from camera 3’ may be defined as auxiliary according to the data categorization set. Here, the image data from camera 3 may be a classified as auxiliary data because the field of view of camera 1 and camera 3 overlap significantly such that it may not be necessary to always have image data from camera 3. As such, any data associated with the data type ‘image data from camera 3’ is determined to be auxiliary data.

The control subsystem 1400 may then determine the measure of auxiliary communication network availability based at least in part on the overall communication network resource availability and the mandatory communication network resource availability. For example, if the measure of overall network resource availability is 5 Megabits per second (Mbps) and the measure of mandatory communication network resource availability is 3 Mbps, the measure of auxiliary communication network resource availability may be determined to be 2 Mbps. In some embodiments, the measure of auxiliary communication network resource availability may refer to a measure of the upload bandwidth dedicated to auxiliary data.

At step/operation 604, the apparatus, such as control subsystem 1400, may include means such as processor 1402, memory 1404, and/or the like for determining a data transmission prioritization policy. The data transmission prioritization policy may describe one or more policies regarding the transmission of the auxiliary data. In particular, the data transmission prioritization policy may describe a priority ranking of auxiliary data, where the priority ranking of auxiliary data is indicative of a prioritization order for which to transmit data associated with auxiliary data. The priority ranking of the data may be based at least in part on an inferred importance associated with the particular data associated with the auxiliary data. For example, a data type of ‘sound signal’ may be determined to be more important relative to a data type of ‘image data from camera 8’, where camera 8 may cover regions already significantly covered by mandatory data. As such, the ‘sound signal’ data type may be assigned to a higher priority ranking than the ‘image data from camera 8’. In other words, the priority ranking of the auxiliary data may be based on at least one of: a degree of overlap of the auxiliary data with mandatory data, additional functionality provided by the auxiliary data compared to the mandatory data, and a degree of AV performance improvement provided by the auxiliary data. Auxiliary data having less overlap, more additional functionality or a higher degree of AV performance improvement may thus be ranked more highly than auxiliary data provided more overlap, less additional functionality or a lower degree of AV performance improvement, for example.

In some embodiments, the data transmission prioritization policy may also describe one or more of a data pre-processing policy indicative of how auxiliary data should be processed prior to being transmitted from the AV 105 and/or a frequency for which the auxiliary data is to be transmitted from the AV 105. For example, a pre-processing routine for any image data may convert raw images into one or more compressed images. As another example, a frequency for the auxiliary data may be determined based on the data packet size associated with the auxiliary data. In instances where the auxiliary data size is large, the auxiliary data may be transmitted less often so as not to exceed to allotted measure of auxiliary communication network availability.

Furthermore, the data transmission prioritization policy may be determined based at least in part on or more operational states associated with the AV 105. The one or more operational states for the AV 105 may be determined based at least in part on one or more signals which are received from one or more sensors carried by the AV, such as one or more of the sensors included in the vehicle sensor subsystem 1644. The control subsystem 1400 may evaluate one or more signal characteristics from the one or more received signals to determine one or more operational states for the AV 105. In some embodiments, the control subsystem may determine an AV operating condition operational state, an environmental operational state, a driving event operational state, and/or navigational operational state. The determination of a particular operational state may affect a priority ranking of the auxiliary data. For example, the receipt of a signal relating to a particular event may result in the determination of an associated operational state of the AV 105. In this case, the priority ranking of auxiliary data relating to the detection of such an event may be adjusted so that such auxiliary data is ranked more highly. The adjustment of priority ranking in this way may occur regardless of a partial overlap of the auxiliary data with mandatory data. Beneficially, adjusting the priority ranking of auxiliary data in response to determining a particular operational state ensures that the auxiliary data most relevant to the current operational state is prioritized. This provides a dynamic adjustment of auxiliary data priority, balancing communication network resource availability with data priority to maximize safe and efficient operation of the AV 105 within the constraints of communication network resource availability. Another example scenario is the operation of cameras when an autonomous vehicle is in forward motion versus when stopped in a position for an extended period of time (e.g., in a minimal risk condition). When travelling, the system may assign higher priority to camera operation which provide views in the direction of travel, usually forward views. Conversely, when pulled-over or stopped, camera operation which provides views from all of the surrounding environment of the autonomous vehicle may be prioritized (e.g., providing 360 degree views in aggregate). In other words, auxiliary data relating to views in the direction of travel may be prioritized during motion in that direction, whereas auxiliary data relating to views of the surrounding environment may be prioritized when the vehicle is not in motion.

The AV operating condition operational state may describe the status of the AV 105 with respect to one or more sensor subsystems 1644, drive subsystems 1642, and/or control subsystems 1648. The AV operating condition operational state may indicate whether the subsystems of the AV 105 are operating normally or abnormally. For example, if a signal from a tire pressure sensor 1646j of sensor subsystem 1644 indicates a tire pressure value that does not satisfy one or more tire pressure threshold values, the AV operating condition operational state may be assigned an ‘abnormal’ value. Furthermore, in some embodiments, the AV operating condition operational state may indicate an associated sensor and/or subsystem which caused the ‘abnormal’ value to be determined. By way of continuing example, the AV operating condition operational state may be assigned values of ‘abnormal’ and ‘tire pressure low’. In other words, the receipt of a signal indicating an “abnormal” value in one or more of the subsystems of the AV 105 may result in the determination of the AV operating condition operational state. Such a determination may thus cause an adjustment in the priority ranking of the auxiliary data. In this example, such an adjustment may be an increase in the ranking of auxiliary data relating to tire pressures, subsystems relating to tire pressures, or an increase in any auxiliary data relating to detecting normal/abnormal operation of the AV. In this manner, the AV may operate more safely and efficiently as additional data relating to an identified problem is prioritized.

The environmental operating state may describe the environmental conditions the AV 105 is operating within. For example, the environmental operational state may indicate the weather conditions and/or temperature of the surrounding environment of the AV 105. In some embodiments, one or more signals from one or more sensors of the sensor subsystem 1644 (e.g., temperature sensors 1646c, cameras 1646a, wiper control system 1646h, etc.) may be used to determine the weather conditions and/or temperature of the surrounding environment either directly or indirectly. For example, the signal from the temperature sensors 1646c may be directly used to determine the temperature of the environment of the AV 105. As another example, the signal from the cameras 1646a may be used indirectly to determine the weather conditions. In particular, one or more images obtained from the one or more cameras 1646a may be analyzed to determine the presence of precipitation. The temperature, as determined using the temperature sensors 1646c may be used in combination with the one or more images to determine the type of precipitation. For example, it may be difficult to discern whether the precipitation determined from the one or more images is snow or rain. However, if the temperature value is above 5° C., the precipitation is classified as rain, if the temperature is below -5° C., the precipitation is classified as snow, and if the temperature is between -5 to 5° C., the precipitation is classified as sleet. Additionally or alternatively, the environmental operational state may indicate the presence of weather events such as hail, tornadoes, floods, hurricanes, thunderstorms, dust storms, wind storms, and/or the like. In other words, the receipt of a signal indicating a weather event may result in the determination of the environmental operational state. Such a determination may thus cause an adjustment in the priority ranking of the auxiliary data. In this example, such an adjustment may be an increase in the ranking of auxiliary data relating to detecting weather events. In this manner, the AV may operate more safely and efficiently as additional data relating to an identified weather event is prioritized.

The driving event operational state may describe one or more driving events with respect to the road segment the AV 105 is operating on. For example, the driving event operational state may indicate one or more driving events such as detection of emergency vehicles, construction zones, vehicle accidents, traffic jams, unexpected objects on the road segment, discrepancies between expected objects from a map and detected objects, and/or the like. In some embodiments, one or more signals from one or more sensors of the sensor subsystem 1644 (e.g., cameras 1646a, radar 1646b, IMUs 1646e, LIDAR 1646f, etc.) may be used to determine the one or more driving events. For example, the one or more images obtained from the one or more cameras 1646a may be analyzed to determine the presence of unexpected objects in a roadway, vehicle accidents, and/or discrepancies between expected objects and detected objects. As another example, one or more signals obtained from cameras (configured with microphones) may be analyzed to determine the presence of sounds characteristic of a driving event, such as sirens, brake screeching, honking, and/or the like. In other words, the receipt of a signal indicating a driving event may result in the determination of the driving event operational state. Such a determination may thus cause an adjustment in the priority ranking of the auxiliary data. In this example, such an adjustment may be an increase in the ranking of auxiliary data relating to detecting driving events. In this manner, the AV may operate more safely and efficiently as additional data relating to an identified driving event is prioritized.

The navigational operational state may describe the current operation of the AV with respect to one or more routes. For example, the navigational operational state may indicate the current operating status of the AV 105 (e.g., moving, stationary, etc.), an operating speed, an operating direction, an acceleration pattern over a time window, a deceleration pattern over a time window, a set of coordinates indicative of the current location of the AV, and/or the like. In some embodiments, one or more signals from one or more sensors of the sensor subsystem 1644 (e.g., cameras 1646a, radar 1646b, IMUs 1646e, LIDAR 1646f, Global Positioning 1646 g, etc.) may be used to determine the navigational operational state. For example, the global positioning sensors 1646 g may indicate a set of coordinates associated with the location of the AV 105, such as a set of GPS coordinates and/or a set of coordinates relative to a particular location (e.g., from a point of origin, a point of destination, an intermediary point, etc.). As another example, signals from the IMU sensors 1646e may be used to determine whether the AV is moving or stationary. The signals from the IMU sensors 1646e may further be used to determine an operation speed, an acceleration profile, and/or deceleration profile over a time window (e.g., over a 5 second period).

In some embodiments, a data transmission prioritization machine learning model is used to determine the data transmission prioritization policy. In some embodiments the data transmission prioritization machine learning model may comprise a neural network. The output of the data transmission prioritization machine learning model may comprise a vector, where each value of the vector describes an auxiliary data type and the order of the values within the vector are indicative of a priority order. For example, the first value in the vector may be associated with the highest priority auxiliary data type and the last value in the vector may be associated with the lowest priority auxiliary data type. In some embodiments, the data transmission prioritization machine learning model may be trained using historical operational state data associated with previous AVs. In some embodiments, the data transmission prioritization machine learning model performs one or more operations to generate a priority score for each auxiliary data type based at least in part on the one or more operational states. In some embodiments, the priority score for each auxiliary data type is determined based at least in part on one or more weighted combinations of the one or more operational states corresponding to the AV. Based at least in part on the priority score for each auxiliary data type, the data transmission prioritization machine learning model may output the vector which includes the list of auxiliary data types ordered according to inferred priority and/or importance. In some embodiments, the data transmission prioritization machine learning model is a rule-based model that is configured to perform one or more operations that are not dependent on any trained parameters, such as one or more operations of a defined equation as described in the preceding sentence. In some embodiments, the data transmission prioritization machine learning model is configured to process n operational states associated with the AV 105 using one or more trained parameters (e.g., one or more trained parameters of a feedforward neural network machine learning model, such as a fully-connected feedforward neural network machine learning model) to generate the list of auxiliary data types ordered according to inferred priority.

In some embodiments, the data transmission prioritization machine learning model comprises an ensemble machine learning model framework such that the data transmission prioritization machine learning model comprises one or more individual operational state machine learning models. Each operational state machine learning model may be configured to process one or more operational states of a particular operational state type. For example, the one or more individual operational state machine learning models may include an AV operating condition operational state machine learning model, an environmental operational state machine learning model, a driving event operational state machine learning model, and/or navigational operational state machine learning model. Each operational state machine learning model may be configured to generate an individual ranked list of auxiliary data types ordered according to inferred priority and provide the list to a data transmission prioritization machine learning model, which may be configured to generate a final individual ranked list of auxiliary data types according to inferred priority. Advantageously, the use of individual operational state machine learning models allows for the operational states of the AV 105 to be processed in parallel, thus reducing the overall computational time for generating the ranked list of auxiliary data types.

In some embodiments, the operation server 1500 may also request one or more auxiliary data types from the AV 105. In response, the control subsystem 1400 may allocate a portion of the measure of auxiliary communication network resource availability to the requested auxiliary data types. The auxiliary data types requested by operation server 1500 may automatically be assigned a priority ranking at the head of the ordered list such that the requested auxiliary data is transmitted regardless of its associated priority score.

In some embodiments, the operation server 1500 may request one or more auxiliary data types based at least in part on mandatory data and/or auxiliary data received from one or more other AVs, one or more AVs not associated with the operation server 1500, and/or one or more third party sources. For example, if an AV provides data indicative of a thunderstorm at a particular location, the operation server may request auxiliary data from AV 105 with a route that includes the particular location. The requested data may be informative of the current weather AV 105 is experiencing (e.g., temperature sensor data, image data, etc.). Additionally, or alternatively, the operation server 1500 may receive weather data indicative of a thunderstorm for a geographic region from a third party weather source. Thus, operation server 1500 may request auxiliary data from AV 105 which is within or expected to be within the geographic region. As such, operation server 1500, which may be privy to information that AV 105 is not, may request auxiliary data that is determined to be pertinent to the operating conditions of AV 105.

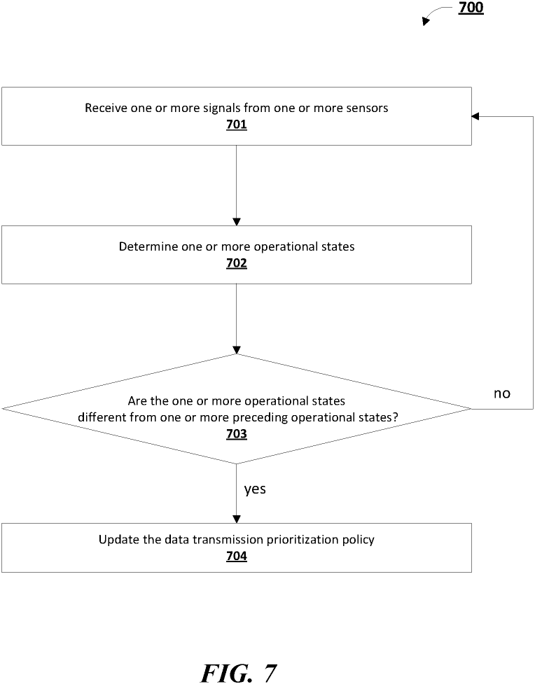

In some embodiments, step/operation 604 may be performed in accordance with the process that is depicted in FIG. 7, which is an example process for updating the data transmission policy. FIG. 7 illustrates a flow chart of an example method 700 for updating a data transmission prioritization policy. The one or more of steps/operations depicted in FIG. 7 may be implemented, at least in part, in the form of software instructions 1408, 1508, and 1680 stored on non-transitory, tangible, machine-readable media (e.g., memories 1404, 1504, 1690, and 1802) that when run by one or more processors (e.g., processors 1402, 1502, 1670, and 1804) may cause the one or more processors to perform steps 601-605. In some embodiments, method 600 may be performed by control subsystem 1400, operation server 1500, and in-vehicle control computer 1650, respectively from FIGS. 2-5.

Beginning at step/operation 701, the apparatus, such as control subsystem 1400, may include means such as processor 1402, memory 1404, and/or the like for receiving one or more signals from one or more sensors. The one or more signals from the one or more sensors pertaining to AV 105 may be received at a time t, where t may be defined by t₀+Δt and t₀ indicates an initial time where the one or more signals (e.g., when the AV 105 began operations, a previous timestep, etc.) were received and Δt indicates an elapsed time since t₀. The one or more received signals may be received from any of the sensors of the vehicle drive subsystems 1642, the vehicle sensor subsystems 1646, and/or the vehicle control subsystems 1648.

At step/operation 702, the apparatus, such as control subsystem 1400, may include means such as processor 1402, memory 1404, and/or the like for determining one or more operational states. As described above, the one or more operational states for the AV 105 may be determined based at least in part on one or more signals which are received from one or more sensors carried by the AV. The control subsystem 1400 may evaluate one or more signal characteristics from the one or more received signals to determine or more operational states for the AV 105. In some embodiments, the control subsystem may determine an AV operating condition operational state, an environmental operational state, a driving event operational state, and/or navigational operational state, as described above.

At step/operation 703, the apparatus, such as control subsystem 1400, may include means such as processor 1402, memory 1404, and/or the like for determining whether the one or more operational states are different from one or more preceding operational states. For example, the one or more preceding operational states may correspond to signals obtained at a time t₀ whereas the one or more operational states may correspond to signals obtained at a time t. In some embodiments, the one or more operational states may be determined at periodic or semi-periodic intervals (e.g., every 10 seconds) and may be used to define Δt. In some embodiments, the operational states may be compared to operational states directly preceding the current operational states. For example, if t₀ corresponds to a time of 9:00:00 and Δt corresponds to a value of 10 seconds, t may correspond to a value of 9:00:10.

In an instance one or more operational states do not differ from one or more preceding operational states, the control subsystem 1400 may return to step/operation 701 and continue to monitor for changes in one or more operational states.

In an instance one or more operational states differ from one or more preceding operational states, control subsystem 1400 may proceed to step/operation 704. At step/operation 704, the apparatus, such as control subsystem 1400, may include means such as processor 1402, memory 1404, and/or the like for updating the data transmission prioritization policy. The control subsystem may update the data transmission prioritization policy based at least in part on the one or more operational states.

As described above with respect to step/operation 604, the data transmission prioritization policy may describe one or more policies regarding the transmission of the auxiliary data. These one or more policies may be updated to reflect the one or more current operational states of the AV 105, such as by using the data transmission prioritization machine learning model. The data transmission prioritization machine learning model may process the one or more operational states associated with the AV 105 to generate a new data transmission prioritization policy, which may replace the previous data transmission prioritization policy. In some embodiments, only the operational states determined to differ from preceding operational states are processed by the data transmission prioritization machine learning model. Alternatively, each operational state associated with the AV 105 are processed to generate the data transmission prioritization policy.

In this way, control subsystem 1400 may selectively update the data transmission prioritization policy only when needed, such as when one or more operational states of the AV 105 change. This advantageously allows the control subsystem 1400 to conserve computational resources while still effectively prioritizing the transmission of auxiliary data.

Returning now to FIG. 6, at step/operation 605, the apparatus, such as control subsystem 1400, may include means such as processor 1402, memory 1404, and/or the like for causing an auxiliary data object of the auxiliary data to be transmitted. The auxiliary data object may be generated based at least in part on the data transmission prioritization policy. For example, the auxiliary data object may be generated to include the top n auxiliary data types according to the data transmission prioritization policy until a measure of auxiliary communication network resource availability is met. In some embodiments, if inclusion of n auxiliary data types causes the auxiliary data object to exceed the measure of auxiliary communication network resource availability, the control subsystem 1400 may include the top n-1 auxiliary data types in the auxiliary data object. As such, the auxiliary data object may include a maximum amount of auxiliary data which is determined to be most pertinent to the operation server 1500 and or other computing entities.

Once the auxiliary data object is generated, the control subsystem 1400 may cause the auxiliary data object to be transmitted to one or more other computing entities, such as operation server 1500 and/or one or more AVs. In some embodiments, the auxiliary data object may be transmitted simultaneously with a mandatory data object which includes mandatory data. In some embodiments, the mandatory data may be included within the auxiliary data object. In some embodiments, the auxiliary data object is transmitted separately from a mandatory data object. In some embodiments, an AV 105 may be fitted with two or more transmitters, where each transmitter is dedicated to transmitting a particular type of data object. For example, an AV 105 may have two transmitters, where a first transmitter is configured to transmit mandatory data objects and a second transmitter is configured to transmit auxiliary data objects. Alternatively, one or more transmitters may be used to transmit both mandatory data objects and auxiliary data objects.

As such, the methods described above allow for the transmission of mandatory data and auxiliary data based on a measure of overall communication network resource availability. The particular auxiliary data types which are transmitted by the AV 105 may be prioritized in accordance to inferred importance based at least in part on one or more operational states of the AV 105. A recipient computing entity, such as operation server 1500 may use the received mandatory and/or auxiliary data to perform one or more operations as described above. For example, the operation server 1500 may determine to update a route associated with the AV 105 and/or other AVs, inform the AV 105 and/or other AVs to perform one or more minimal risk MRC maneuvers, dispatch one or more other vehicles (e.g., mapping vehicles) generate and/or update a map, train one or more models (e.g., data transmission prioritization machine learning model), and/or the like. In some embodiments, the operation server 1500 may provide an update message to the AV 105 indicative of one or more update conditions. For example, the one or more update conditions may indicate an updated route, instructions to perform a MRC maneuver, and/or the like.

Advantageously, embodiments of the present invention contemplate the determination of data transmission based at least in part on overall communication network resource availability (e.g., bandwidth) without the need to consider the QoS associated with said data transmission. This allows for simpler determinations regarding the transmission of data and thus, allows for decreased latency and overall bandwidth usage when transmitting the data. As described above, embodiments of the present invention contemplate the transmission of mandatory data and auxiliary data based at least in part on the overall communication network resource availability and using a data transmission prioritization policy. The data transmission prioritization policy, which may define one or more policies regarding the transmission of auxiliary data, may be determined based at least in part on one or more operational states associated with an AV. In some embodiments, a data transmission prioritization machine learning model may be used to determine the data transmission prioritization policy, such as by using one or more weighted combinations of the one or more operational states corresponding to the AV. An auxiliary data object of the auxiliary data may then be transmitted from the AV based at least in part on the data transmission prioritization policy. As such, an AV may utilize the auxiliary bandwidth network resource availability to provide one or more computing entities with auxiliary data determined to have the highest inferred importance based at least in part on one or more current operational states of the AV.

While several embodiments have been provided in this disclosure, it should be understood that the disclosed systems and methods might be embodied in many other specific forms without departing from the spirit or scope of this disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of this disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

Also disclosed herein are the following numbered clauses:

1. A control subsystem of an autonomous vehicle (AV), the control subsystem comprising processing circuitry configured to:
determine a measure of auxiliary communication network resource availability associated with auxiliary data;
determine a data transmission prioritization policy that: a) describes one or more policies regarding the transmission of the auxiliary data and b) is determined based at least in part on or more operational states associated with the AV; and
cause an auxiliary data object of the auxiliary data to be transmitted from the AV, wherein the auxiliary data object is generated based at least in part on the data transmission prioritization policy.

2. The control subsystem according to clause 1, wherein the processing circuitry, when determining the measure of auxiliary communication network resource availability associated with the auxiliary data, is further configured to:
determine a measure of overall communication network resource availability available to the AV;
determine a measure of mandatory communication network resource availability associated with mandatory data; and
determine the measure of auxiliary communication network resource availability associated with the auxiliary data based at least in part on the measure of overall communication network resource availability and the measure of mandatory communication network resource availability.

3. The control subsystem according to any preceding clause, wherein the processing circuitry is further configured to:

receive one or more signals from one or more sensors carried by the AV; and determine one or more operational states for the AV based at least in part on the one or more received signals.

4. The control subsystem according to clause 3, wherein the processing circuitry is further configured to, in an instance the one or more determined operational states for the AV differ from one or more preceding operational states, update the data transmission prioritization policy.

5. The control subsystem according to any preceding clause, wherein the data transmission prioritization policy at least describes a data pre-processing policy indicative of how data should be processed prior to being transmitted from the AV.

6. The control subsystem according to any preceding clause, wherein the control subsystem further comprises one or more transmitters, wherein the one or more transmitters includes a first transmitter configured to cause at least the auxiliary data object to be transmitted from the AV.

7. The control subsystem according to clause 6, wherein the one or more transmitters includes a second transmitter configured to cause a mandatory data object to be transmitted from the AV.

8. A method comprising:
determining a measure of auxiliary communication network resource availability associated with auxiliary data;
determining a data transmission prioritization policy that: a) describes one or more policies regarding the transmission of the auxiliary data and b) is determined based at least in part on or more operational states associated with the AV; and causing an auxiliary data object of the auxiliary data to be transmitted from the AV, wherein the auxiliary data object is generated based at least in part on the data transmission prioritization policy.

9. The method according to clause 8, wherein determining the measure of auxiliary communication network resource availability associated with the auxiliary data further comprises:
determining a measure of overall communication network resource availability available to the AV;
determining a measure of mandatory communication network resource availability associated with mandatory data; and
determining the measure of auxiliary communication network resource availability associated with the auxiliary data based at least in part on the measure of overall communication network resource availability and the measure of mandatory communication network resource availability.

10. The method according to clause 8 or 9, the method further comprising: receiving one or more signals from one or more sensors carried by the AV; and determining one or more operational states for the AV based at least in part on the one or more received signals.

11. The method according to clause 10, the method further comprising, in an instance the one or more determined operational states for the AV differ from one or more preceding operational states, updating the data transmission prioritization policy.

12. The method according to any of clauses 8 to 11, wherein the data transmission prioritization policy at least describes a data pre-processing policy indicative of how data should be processed prior to being transmitted from the AV.

13. The method according to any of clauses 8 to 12, wherein the one or more operational states describe one or more of environmental operating conditions, driving events, AV operating conditions, or navigational operating conditions.

14. The method according to any of clauses 8 to 13, the method further comprising: receiving one or more transmission type requests that comprise one or more requests for auxiliary data; and

updating the data transmission prioritization policy based at least in part on the one or more transmission type requests.

15. A computer program product comprising at least one non-transitory computer-readable storage medium having computer-executable program code instructions stored therein, the computer-executable program code instructions comprising program code instructions configured to:
determine a measure of auxiliary communication network resource availability associated with auxiliary data;
determine a data transmission prioritization policy that: a) describes one or more policies regarding the transmission of the auxiliary data and b) is determined based at least in part on or more operational states associated with the AV; and
cause an auxiliary data object of the auxiliary data to be transmitted from the AV,
wherein the auxiliary data object is generated based at least in part on the data transmission prioritization policy.

16. The computer program product according to clause 15, wherein the program code instructions are further configured to:
determine a measure of overall communication network resource availability available to the AV;
determine a measure of mandatory communication network resource availability associated with mandatory data; and
determine the measure of auxiliary communication network resource availability associated with the auxiliary data based at least in part on the measure of overall communication network resource availability and the measure of mandatory communication network resource availability.

17. The computer program product according to clause 15 or 16, wherein the program code instructions are further configured to:

receive one or more signals from one or more sensors carried by the AV; and determine one or more operational states for the AV based at least in part on the one or more received signals.

18. The computer program product according to any of clauses 15 to 17, wherein a data transmission prioritization machine learning model is used to determine the data transmission prioritization policy.

19. The computer program product according to any of clauses 15 to 18, wherein the data transmission prioritization policy at least describes one or more data types associated with the auxiliary data to be transmitted from the AV.

20.The computer program product according to any of clauses 15 to 19, wherein the data transmission prioritization policy at least describes a frequency for which the auxiliary data is to be transmitted from the AV.

What is claimed is:

1. A control subsystem of an autonomous vehicle (AV), the control subsystem comprising processing circuitry configured to:
determine a measure of auxiliary communication network resource availability associated with auxiliary data;
determine a data transmission prioritization policy that: a) describes one or more policies regarding the transmission of the auxiliary data and b) is determined based at least in part on one or more operational states associated with the AV; and
cause an auxiliary data object of the auxiliary data to be transmitted from the AV, wherein the auxiliary data object is generated based at least in part on the data transmission prioritization policy.

2. The control subsystem according to claim 1, wherein the processing circuitry, when determining the measure of auxiliary communication network resource availability associated with the auxiliary data, is further configured to:
determine a measure of overall communication network resource availability available to the AV;
determine a measure of mandatory communication network resource availability associated with mandatory data; and
determine the measure of auxiliary communication network resource availability associated with the auxiliary data based at least in part on the measure of overall communication network resource availability and the measure of mandatory communication network resource availability.

3. The control subsystem according to claim 1, wherein the processing circuitry is further configured to:
receive one or more signals from one or more sensors carried by the AV; and
determine one or more operational states for the AV based at least in part on the one or more received signals.

4. The control subsystem according to claim 3, wherein the processing circuitry is further configured to, in an instance the one or more determined operational states for the AV differ from one or more preceding operational states, update the data transmission prioritization policy.

5. The control subsystem according to claim 1, wherein the data transmission prioritization policy at least describes a data pre-processing policy indicative of how data should be processed prior to being transmitted from the AV.

6. The control subsystem according to claim 1, wherein the control subsystem further comprises one or more transmitters, wherein the one or more transmitters includes a first transmitter configured to cause at least the auxiliary data object to be transmitted from the AV.

7. The control subsystem according to claim 6, wherein the one or more transmitters includes a second transmitter configured to cause a mandatory data object to be transmitted from the AV.

8. A method comprising:
determining a measure of auxiliary communication network resource availability associated with auxiliary data;
determining a data transmission prioritization policy that: a) describes one or more policies regarding the transmission of the auxiliary data and b) is determined based at least in part on or more operational states associated with the AV; and
causing an auxiliary data object of the auxiliary data to be transmitted from the AV, wherein the auxiliary data object is generated based at least in part on the data transmission prioritization policy.

9. The method according to claim 8, wherein determining the measure of auxiliary communication network resource availability associated with the auxiliary data further comprises:
determining a measure of overall communication network resource availability available to the AV;
determining a measure of mandatory communication network resource availability associated with mandatory data; and
determining the measure of auxiliary communication network resource availability associated with the auxiliary data based at least in part on the measure of overall communication network resource availability and the measure of mandatory communication network resource availability.

10. The method according to claim 8, the method further comprising:
receiving one or more signals from one or more sensors carried by the AV; and
determining one or more operational states for the AV based at least in part on the one or more received signals.

11. The method according to claim 10, the method further comprising, in an instance the one or more determined operational states for the AV differ from one or more preceding operational states, updating the data transmission prioritization policy.

12. The method according to claim 8, wherein the data transmission prioritization policy at least describes a data pre-processing policy indicative of how data should be processed prior to being transmitted from the AV.

13. The method according to claim 8, wherein the one or more operational states describe one or more of environmental operating conditions, driving events, AV operating conditions, or navigational operating conditions.

14. The method according to claim 8, the method further comprising:
receiving one or more transmission type requests that comprise one or more requests for auxiliary data; and
updating the data transmission prioritization policy based at least in part on the one or more transmission type requests.

15. A computer program product comprising at least one non-transitory computer-readable storage medium having computer-executable program code instructions stored therein, the computer-executable program code instructions comprising program code instructions configured to:
determine a measure of auxiliary communication network resource availability associated with auxiliary data;
determine a data transmission prioritization policy that: a) describes one or more policies regarding the transmission of the auxiliary data and b) is determined based at least in part on or more operational states associated with the AV; and
cause an auxiliary data object of the auxiliary data to be transmitted from the AV, wherein the auxiliary data object is generated based at least in part on the data transmission prioritization policy.

16. The computer program product according to claim 15, wherein the program code instructions are further configured to:
determine a measure of overall communication network resource availability available to the AV;
determine a measure of mandatory communication network resource availability associated with mandatory data; and
determine the measure of auxiliary communication network resource availability associated with the auxiliary data based at least in part on the measure of overall communication network resource availability and the measure of mandatory communication network resource availability.

17. The computer program product according to claim 15, wherein the program code instructions are further configured to:
receive one or more signals from one or more sensors carried by the AV; and
determine one or more operational states for the AV based at least in part on the one or more received signals.

18. The computer program product according to claim 15, wherein a data transmission prioritization machine learning model is used to determine the data transmission prioritization policy.

19. The computer program product according to claim 15, wherein the data transmission prioritization policy at least describes one or more data types associated with the auxiliary data to be transmitted from the AV.

20. The computer program product according to claim 15, wherein the data transmission prioritization policy at least describes a frequency for which the auxiliary data is to be transmitted from the AV.
